(19) United States
(12) Patent Application Publication
(10) Pub. No.: US 2026/0236788 A1
(43) Pub. Date: Aug. 13, 2026

(54) MULTI MODEL FUNCTIONALITY FL TRAINING OF AN AI/ML LEARNING MODEL FOR MULTIPLE MODEL FUNCTIONALITIES

(71) Applicant: Samsung Electronics Co., Ltd., Suwon-si, Gyeonggi-do (KR)

(72) Inventors: Ezeddin Al HAKIM, Staines, Middlesex (GB); Chadi KHIRALLAH, Staines, Middlesex (GB)

(21) Appl. No.: 19/127,054

(22) PCT Filed: Nov. 6, 2023
(86) PCT No.: PCT/KR2023/017618

§ 371 Date: May 2, 2025

(30) Foreign Application Priority Data
Nov. 4, 2022 (GB) 2216457.8
Sep. 29, 2023 (GB) 2315036.0

(51) Int. Cl. G06N 3/098

(52) U.S. Cl. CPC G06N 3/098

(57) ABSTRACT

The disclosure relates to a 5G or 6G communication system for supporting a higher data transmission rate. A multi model functionality FL method is provided used by a first entity of a communications network to train an AI/ML model for multiple related functionalities of the AI/ML model using a group of second network entities of the communications network.

### TECHNICAL FIELD

Certain examples of the present disclosure provide various techniques relating to methods and a communications network for multi model functionality, federated learning (FL) training of an artificial intelligence/machine learning (AI/ML) model for multiple functionalities of the model, for example within 3rd Generation Partnership Project (3GPP) 5th Generation (5G) New Radio (NR) and NR-based relay networks.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The disclosure relates to a method and an apparatus for solving problems such as delay, resource usage, or energy consumption that can occur with regard to an AI/ML model in a wireless communication system.

### Solution to Problem

It is an aim of certain examples of the present disclosure to address, solve and/or mitigate, at least partly, at least one of the problems and/or disadvantages associated with the related art, for example at least one of the problems and/or disadvantages described herein. It is an aim of certain examples of the present disclosure to provide at least one advantage over the related art, for example at least one of the advantages described herein.

The present invention is defined in the independent claims. Advantageous features are defined in the dependent claims. Embodiments or examples disclosed in the description and/or figures falling outside the scope of the claims are to be understood as examples useful for understanding the present invention.

Other aspects, advantages, and salient features of the invention will become apparent to those skilled in the art from the following detailed description taken in conjunction with the accompanying drawings.

### Advantageous Effects of Invention

According to an embodiment of the disclosure, problems such as delay, resource usage, or energy consumption that can occur with regard to an AI/ML model are effectively solved.

### BRIEF DESCRIPTION OF DRAWINGS

FIG. 1 illustrates an example of a federated learning process including a server and K edge nodes;

FIG. 2 illustrates an example of multi task operation, left: parameter sharing for multi model task learning in deep neural learning, right: deep neural learning model for each model task;

FIG. 3 illustrates an example embodiment of a multi model functionality FL method and apparatus which train an AI/ML model for multiple functionalities of the model of the disclosure,

FIG. 4 illustrates a further example embodiment of a multi model functionality FL method and apparatus which train an AI/ML model for multiple functionalities of the model of the disclosure,

FIG. 5 illustrates a flowchart illustrating an embodiment of the present invention,

FIG. 6 illustrates a structure of a first network entity in a wireless communication system according to an embodiment of the present disclosure, and

FIG. 7 illustrates a structure of a second network entity in a wireless communication system according to an embodiment of the present disclosure.

### MODE FOR THE INVENTION

The following description of examples of the present disclosure, with reference to the accompanying drawings, is provided to assist in a comprehensive understanding of the present invention, as defined by the claims. The description includes various specific details to assist in that understanding but these are to be regarded as merely exemplary. Accordingly, those of ordinary skill in the art will recognize that various changes and modifications of the examples described herein can be made.

The following examples are applicable to, and use terminology associated with, 3GPP 5G. However, the skilled person will appreciate that the techniques disclosed herein are not limited to these examples or to 3GPP 5G, and may be applied in any suitable system or standard, for example one or more existing and/or future generation wireless communication systems or standards. The skilled person will appreciate that the techniques disclosed herein may be applied in any existing or future releases of 3GPP 5G NR or any other relevant standard.

For example, the functionality of the various network entities and other features disclosed herein may be applied to corresponding or equivalent entities or features in other communication systems or standards. Corresponding or equivalent entities or features may be regarded as entities or features that perform the same or similar role, function, operation or purpose within the network. For example, the functionality of a UE in the examples below may be applied to any other suitable type of entity performing functions of a network node.

In the 3rd Generation Partnership Project (3GPP) a Rel-18 work item has been agreed, entitled ‘Artificial Intelligence (AI)/Machine Learning (ML) for NG-RAN (the interface between a 5G radio access network (RAN) and a core). The detailed objectives of this are to specify data collection enhancements and signaling support within existing NG-RAN interfaces and architecture (including non-split architecture and split architecture) for AI/ML-based Network Energy Saving, Load Balancing and Mobility Optimization.

The 3GPP has further agreed a work item entitled ‘Study on Artificial Intelligence (AI)/Machine Learning (ML) for NR Air Interface’. This includes a study of the 3GPP framework for AI/ML for an air interface corresponding to each target use case regarding aspects such as performance, complexity, and potential specification impact, including the following.
Initial set of use cases includes: CSI feedback enhancement, beam management and positioning accuracy enhancements.
Protocol aspects, related to, e.g., capability indication, configuration and control procedures (training/inference), and management of data and AI/ML models, in addition to collaboration level specific specification impact per use case.
Specific AI/ML models are not expected to be specified and are left to implementation. User data privacy needs to be preserved.
The study on AI/ML for air interfaces is based on the current RAN architecture and new interfaces shall not be introduced.

### RAN1 #109-e

The following collaboration levels have been agreed.

Taking the following network-UE collaboration levels as one aspect for defining collaboration levels:
1. Level x: no collaboration,
2. Level y: signaling-based collaboration without model transfer,
3. Level z: signaling-based collaboration with model transfer.

Other aspects for defining collaboration levels are not precluded, e.g. with/without model updating, to support training/inference, for defining collaboration levels.

In FFS, clarification is needed for Level x-y boundary.

### RAN2 #119bis-e Assumptions and Agreements

The management of data and AI/ML models focuses on data collection, model transfer, model update, model monitoring and model selection/activation/deactivation/switching/fallback and UE capabilities,
the collaboration level definitions do not clarify what is required, more work is needed,
R2 assumes that for the existing (under discussion) AI/ML use cases, proprietary models may be supported and/or an open format may be supported (and RAN2 may not have to further elaborate on this assumption),
R2 assumes that from a management or control point of view, mainly some meta information about a model may need to be known, details for future study (FFS),
R2 assumes that a model is identified by a model ID, its usage is FFS,
general FFS: AI/ML model delivery to the UE may have different options, control-plane (multiple subvariants), user plane, to be discussed case by case.

### Federated Learning

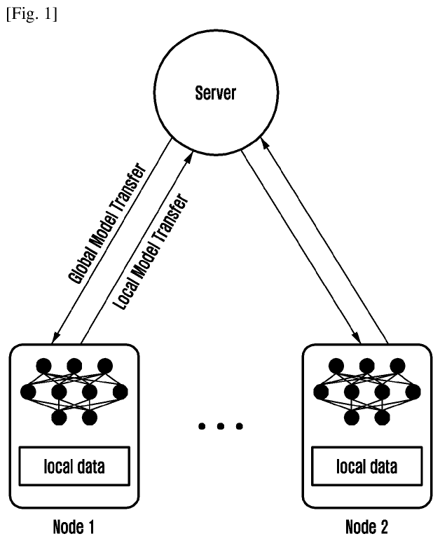

Federated learning (FL) (see FIG. 1) is a distributed AI framework that aims to collaboratively train an AI/ML model over data that has been generated by a set of distributed nodes, without sharing the local data. Centralised AI training requires a central network entity, such as a server, to handle the data management and the training, which leads to communication overhead and risks in data security and privacy.

The classical FL algorithm is FederatedAveraging (FedAvg). This algorithm can be summarised by the following steps.
1. The server initializes a global model with random weights.
2. The server selects random K nodes to participate in the AI training.
3. The server broadcasts the global model to the K nodes.
4. Each node trains and updates the global model by using the local data.
5. Each node sends the updated global model to the server.
6. The server performs aggregation over the received updated global models.
7. The server sends a new global model to each of the K nodes.
8. Repeat step 2 to step 7 until convergence.

### Multi-Tasking

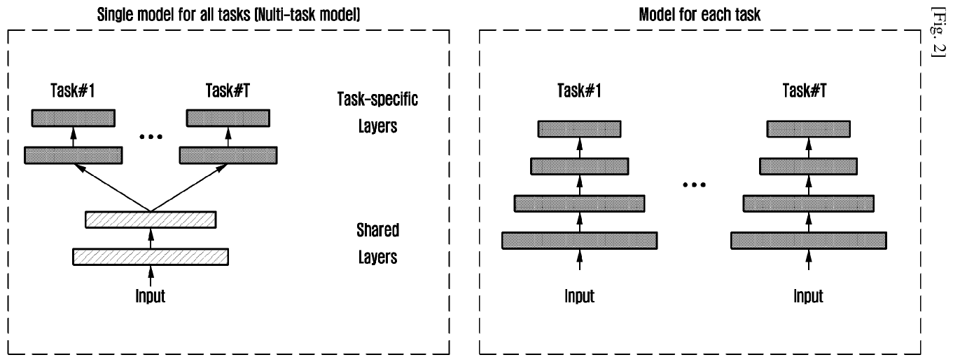

Multi-task learning (MTL) (see FIG. 2) aims to train a unified model for multiple related model functionalities simultaneously, instead of training a model for each model functionality separately. MTL has been used in both classical ML and Deep Neural Learning (DNN). The tasks relationship can be modelled by different approaches, the classical DNN approach is sharing units or layers of the neural network across the model functionalities. The number of shared layers in a multi functionality model can vary, the closer the model functionalities are, the more the layers can be shared. By sharing representations between a set of related model functionalities, MTL can reduce the overfitting, reduce memory space, improve efficiency, and generalize the model for each model functionality by transferring the knowledge between the model functionalities. To train a multi functionality model, an overall loss function has to be designed, which is typically a combination of multiple loss functions, corresponding to multiple model functionalities.

The collaboration levels between a network and a UE for an AI/ML operation, could mandate the need to exchange one or more AI/ML model(s), depending on the AI/ML model functionality performed at the UE side and/or the network side. For example, if the network and/or the UE are required to perform different AI/ML model functionalities, such as mobility optimization, positioning, load balancing, energy saving, and/or any sub functionality of those model functionalities (and/or other model functionalities), the AI/ML model(s) related to those model functionalities would need to be transferred/exchanged between the network and the UE several times (e.g. per AI/ML model functionality) depending on the collaboration level.

Moreover, model transfer would occur during different stages of AI/ML operation, for example, during model download, model training, model inference, model update, and other model management stages.

Model transfer during different AI/ML operation stages is expected to significantly increase signaling overhead, e.g. in terms of the need for new signaling/messages (and/or modification to existing signaling/messages) to transfer AI/ML model(s) and related model data, between the network and the UE.

Moreover, another challenge associated with transfer of AI/ML models and related data, e.g. during joint model training or inference (i.e. training or inference at both the UE and network sides), is the security or privacy concern caused by possible malicious attacks to obtain sensitive information related to the UE or the model parameters.

Other problems are a possible increase in delay, resource usage and/or energy consumption in the network in relation to model transfer.

Methods, based on multi functionality model transfer combined with FL are proposed, to address the problems discussed above associated with frequent transfer of AI/ML models (e.g. full models and/or related model information) between a network and a UE.

The above information is presented as background information only to assist with an understanding of the present disclosure. No determination has been made, and no assertion is made, as to whether any of the above might be applicable as prior art with respect to the present invention.

According to a first aspect of the disclosure, there is provided a multi model functionality FL method used by a first entity of a communications network to train an AI/ML model for multiple functionalities of the AI/ML model using a group of second network entities of the communications network.

According to a second aspect of the disclosure. there is provided a communications network comprising a first network entity and a group of second network entities which perform the method of the first aspect of the disclosure.

There are two example options for performing the multi model functionality FL method.
Option 1: One multi model functionality FL training session for a first network entity and a group of second network entities and multiple model functionalities

The method of the first option may comprise:
1. the first network entity selecting the group of second network entities which comprises entities that have each requested multiple related model functionalities comprising one or more functionality-specific model layers and at least one common model layer and initializing at least one multi model functionality FL training session for at least some of the requested related model functionalities for each of the group of second network entities;
2. the first network entity providing the one or more functionality-specific model layers and the at least one common model layer of the at least some of the requested related model functionalities to each of the group of second network entities;
3. each of the group of second network entities training the one or more provided functionality-specific model layers and the at least one provided common model layer on a local dataset of the entity;
4. each of the group of second network entities sending one or more trained functionality-specific model layers and at least one trained common model layer to the first network entity;
5. the first network entity performing aggregation over the received trained model layers to produce updated model layers and sending the updated model layers to each of the group of second network entities, and
6. the first network entity starting at least one new multi model functionality FL training session and repeating steps 2 to 6 until the at least one new multi model functionality FL training session reaches convergence.

Each of these steps is described more fully below.
Step 1: The first network entity may select a group of second network entities that have requested one or multiple related model functionalities.

In an example embodiment, the first network entity may be any of a NG-RAN, a core network (CN), a server. In an example embodiment, the first network entity may act as a central server and the group of second network entities may act as edge nodes. In an example embodiment, the first network entity and the group of second network entities could be other network entities (including functions) or external entities (including functions).
Step 2: The first network entity may further provide to each of the group of second network entities any of model functionality ID, model functionality version, model functionality update periodicity, model functionality validity time, model functionality validity location, AI/ML model ID related to a model functionality, AI/ML model ID, other model associated information or data.

The first network entity may further provides its multi model functionality FL capability indication to any of each of the group of second network entities, an other network entity.

In one example embodiment, the first network entity may broadcast the one or more functionality-specific model layers and the at least one common model layer. The model layers may be included in system information. The first network entity may broadcast the one or more functionality-specific model layers as part of one or more system information blocks (SIB(s)), or using any newly-defined SIB(s). The first network entity may broadcast the at least one common model layer as part of one or more SIBs, such as common configuration SIB(s), or using any newly-defined SIB(s). The first network entity may broadcast information related to the at least one multi model functionality FL training session, the model layers, and/or model functionalities.

In an alternative example embodiment, the first network entity may exchange or provide the one or more functionality-specific model layers and the at least one common model layer using any of dedicated signaling, existing Radio Resource Control (RRC) signaling/messages, newly-defined RRC signaling/messages, existing Network Access Server (NAS) signaling/messages, newly-defined NAS signaling/messages, any combination thereof.

The first network entity may broadcast the functionally-specific model layers and at least one common model layer via broadcast included in system information. The first network entity may broadcast the at least one common model layer as part of a common configuration SIB(s), or using any newly-defined SIB(s).

In an alternative embodiment, the first network entity may exchange or provide information related to the multi model functionality FL training sessions, model layers, and/or functionalities using dedicated signaling (for example existing or newly-defined RRC and/or NAS signaling/messages).
Step 3: Each of the group of second network entities then trains the one or more functionality-specific model layers provided to it and the at least one common model layer provided to it on its local dataset.

In one example embodiment, each of the group of second network entities may train the one or more functionality-specific model layers, the at least one common model layer and one or more second network entity specific layers. This may be used to personalise the multi functionality AI/ML model. The second network entity specific layers may be kept locally and may not be sent to the first network entity.
Step 4: Each of the group of second network entities sends the one or more trained functionality-specific model layers and the at least one trained common model layer to the first network entity.
Step 5: The first network entity performs aggregation over the received trained model layers to produce updated model layers and sends the updated model layers to each of the group of second network entities.
Step 6: The first network entity starts at least one new multi model functionality FL training session and repeats the above-described actions until the at least one multi model functionality FL training session reaches convergence.
Option 2: Multiple multi model functionality FL training sessions for a first network entity and a group of second network entities and multiple model functionalities

The method of the second option may comprise:
1. the first network entity selecting the group of second network entities which comprises entities that have each requested multiple related model functionalities comprising one or more functionality-specific model layers and at least one common model layer and initializing a multi model functionality FL training session for one or more functionality-specific model layers of the at least some of the requested related model functionalities and a multi model functionality FL training session for at least one common model layer of the at least some of the requested related model functionalities;
2. the first network entity providing the one or more functionality-specific model layers and the at least one common model layer of the at least some of the requested related model functionalities to each of the group of second network entities;
3. each of the group of second network entities training the one or more provided functionality-specific model layers and the at least one provided common model layer on a local dataset of the entity;
4. each of the group of second network entities sending one or more trained functionality-specific model layers and at least one trained common model layer to the first network entity;
5. the first network entity performing aggregation over the received trained model layers to produce updated model layers and sending the updated model layers to each of the group of second network entities, and
6. the first network entity starting at least one new multi model functionality FL training session and repeating steps 2 to 6 until the at least one new multi model functionality FL training session reaches convergence.

Each of these steps is described more fully below.
Step 1: The first network entity may select a group of second network entities that have requested one or multiple related model functionalities.

Each of the multi model functionality FL training sessions may have a different training time and different periodicity updates. This can be beneficial in decreasing signaling overhead by having less frequent updating of the at least one common model layer (having a large number of parameters) and more frequent updating of the functionality-specific model layers (having a small number of parameters).

Each of the group of second network entities may belong to one or more multi model functionality FL training sessions.

In an example embodiment, the first network entity may be any of a NG-RAN, a core network (CN), a server. In an example embodiment, the first network entity may act as a central server and the group of second network entities may act as edge nodes. In an example embodiment, the first network entity and the group of second network entities could be other network entities (including functions) or external entities (including functions).
Step 2: For each multi model functionality FL training session, the first network entity provides the one or more functionality-specific model layers and the at least one common model layer of the at least some of the requested related model functionalities to each of the group of second network entities.

The first network entity may further provide to each of the group of second network entities any of model functionality ID, model functionality version, model functionality update periodicity, model functionality validity time, model functionality validity location, AI/ML model ID related to a model functionality, AI/ML model ID, other model associated information or data.

The first network entity may further provides its multi model functionality FL capability indication to any of each of the group of second network entities, an other network entity.

In one example embodiment, the first network entity may broadcast the one or more functionality-specific model layers and the at least one common model layer. The model layers may be included in system information. The first network entity may broadcast the one or more functionality-specific model layers as part of one or more system information blocks (SIB(s)), or using any newly-defined SIB(s). The first network entity may broadcast the at least one common model layer as part of one or more SIBs, such as common configuration SIB(s), or using any newly-defined SIB(s). The first network entity may broadcast information related to the at least one multi model functionality FL training session, the model layers, and/or model functionalities.

In an alternative example embodiment, the first network entity may exchange or provide the one or more functionality-specific model layers and the at least one common model layer using any of dedicated signaling, existing Radio Resource Control (RRC) signaling/messages, newly-defined RRC signaling/messages, existing Network Access Server (NAS) signaling/messages, newly-defined NAS signaling/messages, any combination thereof.

The first network entity may broadcast the functionally-specific model layers and at least one common model layer via broadcast included in system information. The first network entity may broadcast the at least one common model layer as part of a common configuration SIB(s), or using any newly-defined SIB(s).

In an alternative embodiment, the first network entity may exchange or provide information related to the multi model functionality FL training sessions, model layers, and/or functionalities using dedicated signaling (for example existing or newly-defined RRC and/or NAS signaling/messages).
Step 3: Each of the group of second network entities then trains the one or more functionality-specific model layers provided to it and the at least one common model layer provided to it on its local dataset.

In one embodiment, each of the group of second network entities trains the one or more functionality-specific model layers, the at least one common model layer and one or more second network entity specific model layers. This may be used to personalise the multi functionality AI/ML model. The second entity specific model layers may be kept locally and may not be sent to the first network entity.
Step 4: Each of the group of second network entities sends one or more trained functionality-specific model layers and at least one trained common model layer to the first network entity.
Step 5: For each multi model functionality FL training session, the first network entity performs aggregation over the received trained one or more functionality-specific model layers and the at least one received trained common model layer to produce updated model layers and sends the updated model layers to each of the group of second network entities

The aggregation process for each multi model functionality FL training session may be performed at the same time as or at different times as other multi model functionality FL training sessions.
Step 6: The first network entity starts a new multi model functionality FL training session for one or more functionality-specific model layers and a new multi model functionality FL training session for at least one common model layer and repeats the above-described actions until the multi model functionality FL training sessions reached convergence.

The skilled person will appreciate that the techniques described herein are applicable to various types of network entity, including eNB, gNB, E-UTRAN and/or NG-RAN node and related RRC signaling and/or messages.

The proposed methods and communications network use a MTL concept to enable a first network entity and a group of second network entities to re-use parts of a AI/ML model, trained for a given model functionality (task/use case) in the training of the AI/ML model for other related model functionalities (tasks/use cases). The proposed methods and communications network use a MTL concept to enable the first network entity and the group of second network entities to re-use trained common model layers which are common to multiple model functionalities. This is instead of training the AI/ML model layers separately, multiple times for the multiple related model functionalities. The method and apparatus will reduce the overall signaling overhead related to separate training of AI/ML models for multiple model functionalities.

The proposed methods and communication network transfer model layers during model training and update stages for multi functionality learning (MFL) between the first network entity and the group of second network entities.

The proposed methods and communication network can be considered for related training model functionalities. For example, assuming that a given AI/ML model has been trained for a mobility optimisation model functionality, trained common model layers of this trained AI/ML model can be re-used in training of other related model functionalities, such as positioning accuracy/optimisation, energy saving, and load balancing. The assumption is that the related model functionalities have at least one common model layer and share similar training stages, objectives, outcomes, KPIs and/or data, related, for example, to second network entity location, trajectory, velocity, position, and/or other measurements at a given time and place.

The proposed methods and communication network provide solutions to reduce the need for frequent transfer of AI/ML models and the size of models and/or model information transferred, between the first network entity and the group of second network entities.

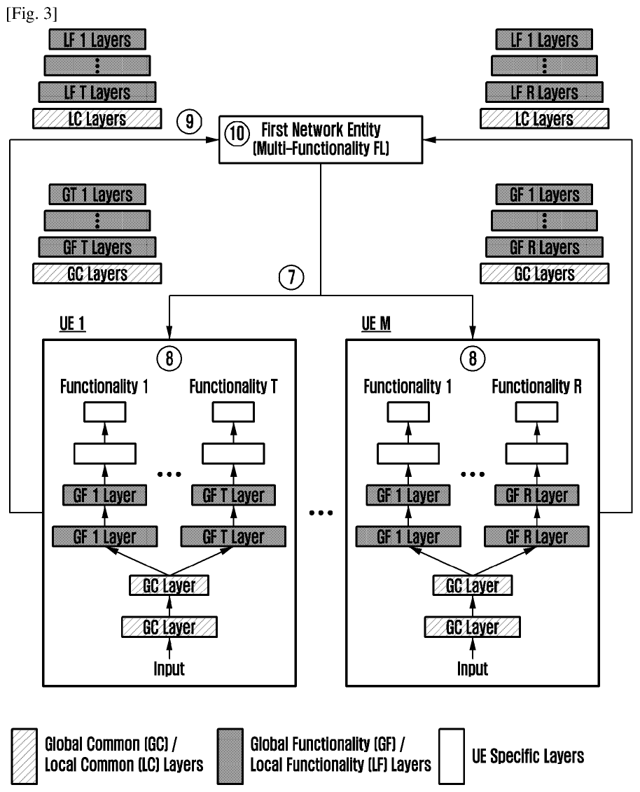

Referring to FIG. 3, there is now described an example embodiment of the proposed methods and communication network of the present disclosure performing option 1 for the multi model functionality FL, i.e. one multi model functionality FL training session for a first network entity and a group of second network entities and multiple model functionalities.

In the following we describe a proposed method and communication network which enables model layer transfer between a first network entity and a group of second network entities in multi model functionality FL training.

The communications network of FIG. 3 comprises a first network entity, a NG-RAN, and a group of second network entities, UE 1 to UE M. It will be appreciated that the first network entity may comprise other network entities or functions, such as any of a CN, a server, an internal network entity, an external network entity, a network function, an application function (AF). It will be appreciated that the second network entities may comprise other network entities or functions.

In this example embodiment, the related model functionalities may comprise any of a mobility optimisation model functionality, a positioning accuracy and optimisation model functionality, an energy saving model functionality, a load balancing model functionality. The related model functionalities may comprise related model sub-functionalities.

In this example embodiment, there are initial steps 1 to 5 which are performed before the steps 1 to 6 (now steps 6 to 11) of the option 1 for the multi model functionality FL.

### Step 1

The first network entity provides one or more functionality-specific model layers and at least one common model layer of at least some of the requested related model functionalities to each of the group of second network entities.

This comprises:
the first network entity providing a list of available related model functionalities to each of the group of second network entities;
each of the group of second network entities sending a list of requested related model functionalities from the list of available related model functionalities to the first network entity;
the first network entity verifying the list of requested related model functionalities from each second network entity;
the first network entity allocating a list of verified related model functionalities to each of the group of second network entities;
the first network entity providing the allocated list of verified related model functionalities to each of the group of second network entities, and
the first network entity providing one or more functionality-specific model layers and at least one common model layer of the verified related model functionalities of the allocated list of verified related model functionalities to each of the group of second network entities.

The first network entity may further provide to the group of second network entities any of model functionality ID, model functionality version, model functionality update periodicity, model functionality validity time, model functionality validity location, model ID related to a model functionality, model ID.

The first network entity may provide the list of available related model functionalities to each of the group of second network entities using RRC signaling/messages or NAS signaling/messages or system broadcast, which may be periodically or on-demand, or any combination of these signaling methods. The first network entity may also send its multi model functionality FL capability indication to the group of second network entities and/or another network entity.

### Step 2

Each of the group of second network entities further sends any of its multi model functionality FL capability indication, a list of related AI/ML models to the first network entity.

Each of the group of second network entities sends the list of requested related model functionalities to the first network entity using any of an existing information element (IE), a newly-defined IE, existing NAS signaling/messages, newly-defined NAS signaling/messages, existing RRC signaling/messages, newly-defined RRC signaling/messages. For example, the list of requested related model functionalities may be sent using an existing or a newly-defined IE, “List of Requested Related Model Functionalities IE”, using existing and/or newly-defined NAS signaling/messages, RRC signaling/messages, for example RRCResumeComplete, RRCRestablishement-Complete, RRCSetupComplete and/or any other suitable RRC message.

The group of second network entities may send the list of requested related model functionalities to the first network entity together with any of one or more second network entity multi model functionality FL capability indications, a list of related AI/ML models.

The group of second network entities may send one or more second network entity multi model functionality FL capability indications to the first network entity separately of the list of requested related model functionalities.

The group of second network entities may send one or more second network entity multi model functionality FL capability indications to the first network entity following a request from the first network entity for information on this capability.

The first network entity may forward the one or more second network entity multi model functionality FL capability indications of the group of second network entities to another network entity.

The first network entity may forward the one or more second network entity multi model functionality FL capability indications of the group of the second network entities to another network entity following a request from that network entity.

The one or more second network entity multi model functionality FL capability indications may indicate to the first network entity whether a second network entity supports multi model functionality FL training.

### Step 3

The first network entity verifies the list of requested related model functionalities from each of the group of second network entities. The first network entity may verify the list of requested model functionalities based on any of a second entity subscription information, PLMN rules, a second network entity capability to support AI/ML (e.g. general and/or functionality-specific capability), a second network entity indication of AI/ML capabilities to the first network entity, other rules preconfigured in the communications network, e.g. by any of a service provider, an application function (AF), an network operator, the communications network, an external entity, via OAM, and any combination of the previous.

### Step 4

The first network entity allocates a list of verified related model functionalities to the group of second network entities. The list may include, if supported and/or available, any of the requested list of related model functionalities, part of the requested list of related model functionalities, a different list of related model functionalities to those in the requested list of related model functionalities.

The allocated list of verified related model functionalities may further include any of model functionality IDs, model functionality layers, model functionality layer IDs.

### Step 5

The first network entity provides the allocated list of verified related model functionalities to each of the group of second network entities.

The first network entity may provide the allocated list of verified related model functionalities to each of the group of second network entities using any of an existing information element, a newly-defined information element, existing NG signaling/messages, newly-defined NG signaling/messages.

The first network entity may provide the list of verified related model functionalities to each of the group of second network entities using any of an existing IE, a newly-defined IE, (for example “List of Verified Related Model Functionalities IE”, “List of Related Model Functionalities IE”, “List of Model Functionalities IE”), existing NG signaling/messages, newly-defined NG signaling/messages.
In one example embodiment, the first network entity may store the “List of Verified Related Model Functionalities IE” in a second network entity capability, if supported and/or available.
In one example embodiment, the first network entity may provide the “List of Verified Related Model Functionalities IE” using existing or newly-defined NG signaling/messages. For example, included in:
INITIAL CONTEXT SETUP REQUEST message and/or UE CONTEXT MODIFICATION REQUEST message.
In one example embodiment, the first network entity may send the “List of Verified Related Model Functionalities IE” (and/or any model functionality related information). For example, the first network entity (e.g. AMF) may send information on model functionalities (or the “List of Verified Related Model Functionalities IE” to an other network entity (e.g. NG-RAN node) using any of the following messages:
AMF CP RELOCATION INDICATION message, UE INFORMATION TRANSFER message, HANDOVER REQUEST message and/or PATH SWITCH REQUEST ACKNOWLEDGE message.
In one example embodiment, the first network entity, e.g. an AMF or other network entity/function of the network, may inform an other network entity, e.g. a NG-RAN node, if a second network entity or second group of network entities, e.g. UE(s), is capable of performing/supporting multi model functionality learning and/or FL.

Based on this information, the other network entity may directly obtain the “List of Verified Related Model Functionalities IE” (and any related information) from the other network entity or node or function or a newly-defined network entity or network function that can be dedicated to store, manage, and share AI/ML models and/or model functionalities.

### Step 6

The first network entity initializes a multi model functionality FL training session and selects a group of second network entities that have requested one or multiple related model functionalities. The related model functionalities may have similar learning stages, e.g. training stages.

In an example embodiment, the first network entity may be any of a NG-RAN, a core network (CN), a server. In an example embodiment, the first network entity may act as a central server and the group of second network entities may act as edge nodes. In an example embodiment, the first network entity and the group of second network entities could be other network entities (including functions) or external entities (including functions).

### Step 7

The model layers of the related model functionalities may comprise any of Global Common (GC) model layers, Local Common (LC) model layers, Global Functionality (GF) model layers, Local Functionality (LF) model layers.

The first network entity may further provide to each of the group of second network entities any of model functionality ID, model functionality version, model functionality update periodicity, model functionality validity time, model functionality validity location, AI/ML model ID related to a model functionality, AI/ML model ID, other model associated information or data.

The first network entity may further provide its multi model functionality FL capability indication to any of each of the group of second network entities, an other network entity.

In one example embodiment, the first network entity may broadcast the one or more functionality-specific model layers and the at least one common model layer. The model layers may be included in system information. The first network entity may broadcast the one or more functionality-specific model layers as part of one or more system information blocks (SIB(s)), or using any newly-defined SIB(s). The first network entity may broadcast the at least one common model layer as part of one or more SIBs, such as common configuration SIB(s), or using any newly-defined SIB(s). The first network entity may broadcast information related to the at least one multi model functionality FL training session, the model layers, and/or model functionalities.

In an alternative example embodiment, the first network entity may exchange or provide the one or more functionality-specific model layers and the at least one common model layer using any of dedicated signaling, existing Radio Resource Control (RRC) signaling/messages, newly-defined RRC signaling/messages, existing Network Access Server (NAS) signaling/messages, newly-defined NAS signaling/messages, any combination thereof.

The first network entity may broadcast the functionally-specific model layers and at least one common model layer via broadcast included in system information. The first network entity may broadcast the at least one common model layer as part of a common configuration SIB(s), or using any newly-defined SIB(s).

In an alternative embodiment, the first network entity may exchange or provide information related to the multi model functionality FL training sessions, model layers, and/or functionalities using dedicated signaling (for example existing or newly-defined RRC and/or NAS signaling/messages).

### Step 8

Each of the group of second network entities then trains the one or more functionality-specific model layers provided to it and the at least one common model layer provided to it on its local dataset.

In one example embodiment, each of the group of second network entities may train the one or more functionality-specific model layers, the at least one common model layer and one or more second network entity specific layers. This may be used to personalise the multi functionality AI/ML model. The second network entity specific layers may be kept locally and may not be sent to the first network entity.

### Step 9

Each of the group of second network entities sends the one or more trained functionality-specific model layers and the at least one trained common model layer to the first network entity.

### Step 10

The first network entity performs aggregation over the received trained model layers to produce updated model layers and sends the updated model layers to each of the group of second network entities.

### Step 11

The first network entity starts at least one new multi model functionality FL training session and repeats the above-described actions until the at least one multi model functionality FL training session reaches convergence.

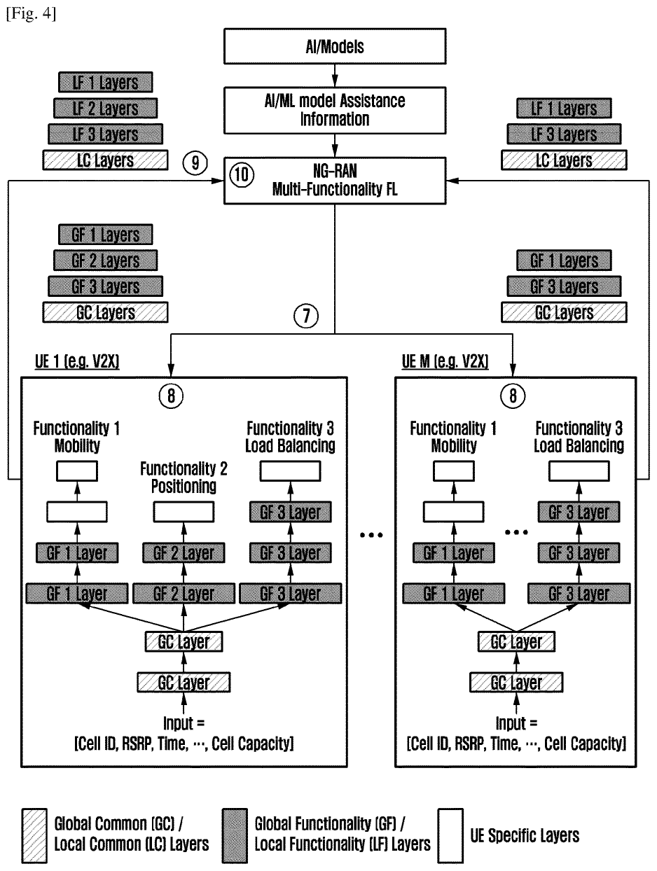

Referring to FIG. 4, there is now described a further example embodiment of the method and apparatus of the present disclosure.

The communications network of FIG. 4 comprises a first network entity, the NG-RAN, and a group of second network entities, UE 1 to UE M. It will be appreciated that the first network entity may comprise other network entities or functions, such as any of a CN, a server, an internal network entity, an external network entity, a network function, an application function (AF).

In this embodiment, the related model functionalities comprise a mobility optimisation model functionality, a positioning accuracy and optimisation model functionality and a load balancing model functionality. It will be appreciated that other related model functionalities or related model sub-functionalities may be used. The proposed method and apparatus can be applied to any set of related model functionalities which share the same input. Sharing the representations between the related model functionalities reduces required memory space and improves efficiency of the method and apparatus.

In FIG. 4 the three related model functionalities share the same input and are:
a mobility model functionality: used to predict future locations of the group of second entities,
a positioning model functionality: used to predict positions of the group of second entities,
a load balancing model functionality: used to distribute the group of second entities across multiple carriers or cells.

The input to the three related model functionalities can be defined with the following KPIs:
second entity's connected cell ID,
second entity's neighbours cell ID,
second entity's connected cell RSRP,
second entity's neighbours cell RSRP,
second entity's connected capacity,
second entity's connected coverage,
second entity's historical information (e.g. last x position, last x visited cell IDs and other),
current time, day, week,
other information.

The above-described steps 1 to 11 are used in the method and apparatus shown in FIG. 4 to perform multi model functionality FL training of an AI/ML model for the three related functionalities of the model, as shown in the figure.

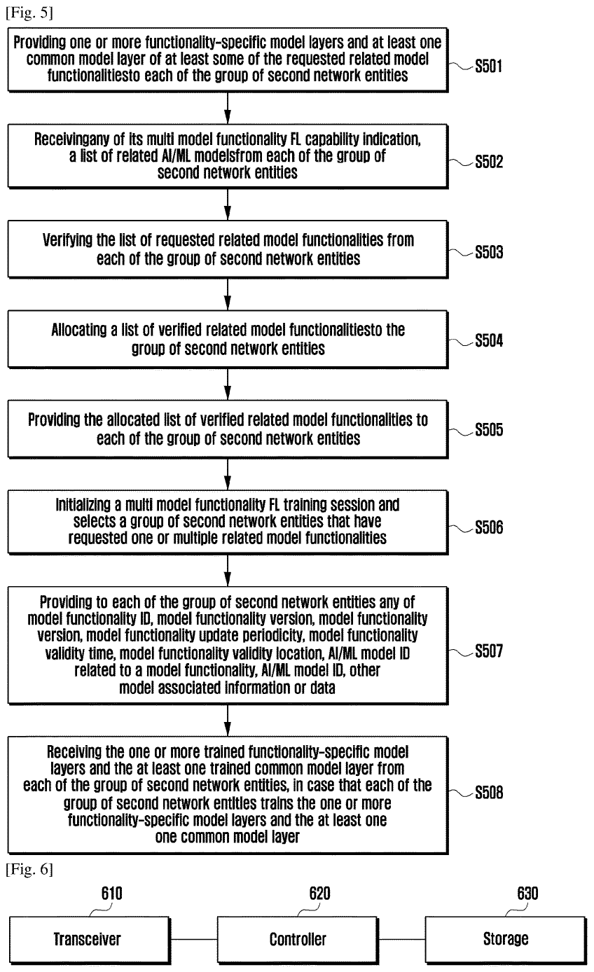

FIG. 5 illustrates a flowchart illustrating an embodiment for the option 1 of the present invention.
At S501, the first network entity provides one or more functionality-specific model layers and at least one common model layer of at least some of the requested related model functionalities to each of the group of second network entities.
At S502, each of the group of second network entities further sends any of its multi model functionality FL capability indication, a list of related AI/ML models to the first network entity.
At S503, the first network entity verifies the list of requested related model functionalities from each of the group of second network entities.
At S504, the first network entity allocates a list of verified related model functionalities to the group of second network entities.
At S505, the first network entity provides the allocated list of verified related model functionalities to each of the group of second network entities.
At S506, the first network entity initializes a multi model functionality FL training session and selects a group of second network entities that have requested one or multiple related model functionalities.
At S507, the first network entity may further provide to each of the group of second network entities any of model functionality ID, model functionality version, model functionality update periodicity, model functionality validity time, model functionality validity location, AI/ML model ID related to a model functionality, AI/ML model ID, other model associated information or data.
At S508, the first network entity may receive the one or more trained functionality-specific model layers and the at least one trained common model layer from each of the group of second network entities, in case that each of the group of second network entities trains the one or more functionality-specific model layers provided to it and the at least one common model layer provided to it on its local dataset.
At S509, the first network entity performs aggregation over the received trained model layers to produce updated model layers and sends the updated model layers to each of the group of second network entities.
At S510, the first network entity starts at least one new multi model functionality FL training session and repeats the above-described actions until the at least one multi model functionality FL training session reaches convergence.

FIG. 6 illustrates a structure of a first network entity in a wireless communication system according to an embodiment of the present disclosure.

A first network entity of FIG. 6 may be one of a NG-RAN, a core network (CN), or a server.

Referring to FIG. 6, a first network entity may include a transceiver 610, a controller 620, and a storage 630. In the present disclosure, the controller may be defined as a circuit, an application-specific integrated circuit, or at least one processor.

The transceiver 610 may transmit or receive a signal to or from other network entities. For example, the transceiver 610 may transmit or receive a signal or a message to or from each of the group of second network entities.

The controller 620 may control an overall operation of a first network entity such that the the first network entity can operate according to embodiments proposed in the present disclosure. For example, the controller 620 may control a signal flow between blocks so as to perform an operation according to the above-described flowchart.

The storage 630 may store at least one of information transmitted or received via the transceiver 610 and information generated via the controller 620.

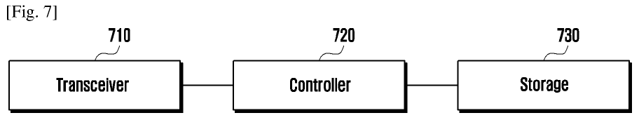

FIG. 7 illustrates a structure of a second network entity in a wireless communication system according to an embodiment of the present disclosure.

Referring to FIG. 7, the second network entity may include a transceiver 710, a controller 720, and a storage 730. In the present disclosure, the controller may be defined as a circuit, an application-specific integrated circuit, or at least one processor.

The transceiver 710 may transmit or receive a signal to or from other network entities. For example, the transceiver 710 may transmit or receive a signal or a message to or from a first network entity.

The controller 720 may control an overall operation of a second network entity such that the the first network entity can operate according to embodiments proposed in the present disclosure. For example, the controller 720 may control a signal flow between blocks so as to perform an operation according to the above-described flowchart.

The storage 730 may store at least one of information transmitted or received via the transceiver 710 and information generated via the controller 720.

The skilled person will appreciate that the present invention is not limited to the specific examples disclosed herein. For example:
The techniques disclosed herein are not limited to 3GPP 5G.
One or more entities in the examples disclosed herein may be replaced with one or more alternative entities performing equivalent or corresponding functions, processes or operations.

One or more of the messages in the examples disclosed herein may be replaced with one or more alternative messages, signals or other type of information carriers that communicate equivalent or corresponding information.
One or more further elements, entities and/or messages may be added to the examples disclosed herein.
One or more non-essential elements, entities and/or messages may be omitted in certain examples.
The functions, processes or operations of a particular entity in one example may be divided between two or more separate entities in an alternative example.
The functions, processes or operations of two or more separate entities in one example may be performed by a single entity in an alternative example.
Information carried by a particular message in one example may be carried by two or more separate messages in an alternative example.
Information carried by two or more separate messages in one example may be carried by a single message in an alternative example.
The order in which operations are performed may be modified, if possible, in alternative examples.
The transmission of information between network entities is not limited to the specific form, type and/or order of messages described in relation to the examples disclosed herein.

To satisfy extremely high data rate requirements, the 3GPP 5G NR standard utilises communication frequencies in a relatively high range, from 30 GHz to 300 GHz, corresponding to wavelengths in the millimetre (mm) range (mmWave communication). Such mmWave communication provides a large available bandwidth and high transmission speeds. However, problems with mmWave communication include severe signal path loss and low penetration, resulting in a relatively short transmission range. This in turn requires a greater density of base stations deployment.

Certain examples of the present disclosure provide a network or wireless communication system comprising a first network entity and a second network entity according to any example, embodiment, aspect and/or claim disclosed herein.

Certain examples of the present disclosure provide a computer program comprising instructions which, when the program is executed by a computer or processor, cause the computer or processor to carry out a method according to any example, embodiment, aspect and/or claim disclosed herein.

Certain examples of the present disclosure provide a computer or processor-readable data carrier having stored thereon a computer program according to the preceding examples.

Certain examples of the present disclosure may be provided in the form of an apparatus/device/network entity configured to perform one or more defined network functions and/or a method therefor. Such an apparatus/device/network entity may comprise one or more elements, for example one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). Certain examples of the present disclosure may be provided in the form of a system (e.g. a network) comprising one or more such apparatuses/devices/network entities, and/or a method therefor. For example, in the following examples, a network may include one or more IAB nodes.

It will be appreciated that examples of the present disclosure may be realized in the form of hardware, software or a combination of hardware and software. Certain examples of the present disclosure may provide a computer program comprising instructions or code which, when executed, implement a method, system and/or apparatus in accordance with any aspect, claim, example and/or embodiment disclosed herein. Certain embodiments of the present disclosure provide a machine-readable storage storing such a program.

The same or similar components may be designated by the same or similar reference numerals, although they may be illustrated in different drawings.

Detailed descriptions of techniques, structures, constructions, functions or processes known in the art may be omitted for clarity and conciseness, and to avoid obscuring the subject matter of the present disclosure.

The terms and words used herein are not limited to the bibliographical or standard meanings, but, are merely used to enable a clear and consistent understanding of the examples disclosed herein.

Throughout the description and claims, the words “comprise”, “contain” and “include”, and variations thereof, for example “comprising”, “containing” and “including”, means “including but not limited to”, and is not intended to (and does not) exclude other features, elements, components, integers, steps, processes, functions, characteristics, and the like.

Throughout the description and claims, the singular form, for example “a”, “an” and “the”, encompasses the plural unless the context otherwise requires. For example, reference to “an object” includes reference to one or more of such objects.

Throughout the description and claims, language in the general form of “X for Y” (where Y is some action, process, function, activity or step and X is some means for carrying out that action, process, function, activity or step) encompasses means X adapted, configured or arranged specifically, but not necessarily exclusively, to do Y.

Features, elements, components, integers, steps, processes, functions, characteristics, and the like, described in conjunction with a particular aspect, embodiment, example or claim are to be understood to be applicable to any other aspect, embodiment, example or claim disclosed herein unless incompatible therewith.

While the invention has been shown and described with reference to certain examples, it will be understood by those skilled in the art that various changes in form and detail may be made therein without departing from the scope of the invention, as defined by the appended claims.

1. A multi model functionality federated learning, FL, method used by a first entity of a communications network to train an artificial intelligence/machine learning, AI/ML, model for multiple related functionalities of the AI/ML model using a group of second network entities of the communications network.

2. A method according to claim 1, comprising:
the first network entity selecting the group of second network entities which comprises entities that have each requested multiple related model functionalities comprising one or more functionality-specific model layers and at least one common model layer and initializing at least one multi model functionality FL training session for at least some of the requested related model functionalities for each of the group of second network entities;
the first network entity providing the one or more functionality-specific model layers and the at least one common model layer of the at least some of the requested related model functionalities to each of the group of second network entities;
each of the group of second network entities training the one or more provided functionality-specific model layers and the at least one provided common model layer on a local dataset of the entity;
each of the group of second network entities sending one or more trained functionality-specific model layers and at least one trained common model layer to the first network entity;
the first network entity performing aggregation over the received trained model layers to produce updated model layers and sending the updated model layers to each of the group of second network entities, and
the first network entity starting at least one new multi model functionality FL training session and repeating steps 2 to 6 until the at the least one new multi model functionality FL training session reaches convergence.

3. A method according to claim 2, in which the first network entity initializing at least one multi model functionality FL training session for at least some of the requested related model functionalities for each of the group of second network entities, comprises initializing a multi model functionality FL training session for one or more functionality-specific model layers of the at least some of the requested related model functionalities and a multi model functionality FL training session for at least one common model layer of the at least some of the requested related model functionalities.

4. A method according to claim 2, in which the first network entity providing the one or more functionality-specific model layers and the at least one common model layer of the at least some of the requested related model functionalities to each of the group of second network entities, comprises:
the first network entity providing a list of available related model functionalities to each of the group of second network entities;
each of the group of second network entities sending a list of requested related model functionalities from the list of available related model functionalities to the first network entity;
the first network entity verifying the list of requested related model functionalities from each second network entity;
the first network entity allocating a list of verified related model functionalities to each of the group of second network entities;
the first network entity providing the allocated list of verified related model functionalities to each of the group of second network entities, and
the first network entity providing one or more functionality-specific model layers and at least one common model layer of the verified related model functionalities of the allocated list of verified related model functionalities to each of the group of second network entities.

5. A method according to claim 2, in which the first network entity further provides to each of the group of second network entities any of model functionality ID, model functionality version, model functionality update periodicity, model functionality validity time, model functionality validity location, AI/ML model ID related to a model functionality, AI/ML model ID, other model associated information or data.

6. A method according to claim 2, in which the first network entity provides the one or more functionality-specific model layers and the at least one common model layer to each of the group of second network entities by any of broadcasting, broadcasting as part of one or more system information blocks, broadcasting using one or more newly-defined system information blocks, dedicated signaling, existing RRC signaling/messages, newly-defined RRC signaling/messages, existing NAS signaling/messages, newly-defined NAS signaling/messages, any combination thereof.

7. A method according to claim 2, in which each of the group of second network entities trains the one or more functionality-specific model layers, the at least one common model layer and one or more second network entity specific layers.

8. A method according to claim 2, in which the first network entity further provides its multi model functionality FL capability indication to any of each of the group of second network entities, an other network entity.

9. A method according to claim 4, in which the first network entity provides the list of available related model functionalities to each of the group of second network entities using any of RRC signaling/messages, NAS signaling/messages, system broadcasting, any combination thereof.

10. A method according to claim 4, in which each of the group of second network entities further sends any of its multi model functionality FL capability indication, a list of related AI/ML models to the first network entity.

11. A method according to claim 4, in which each of the group of second network entities sends the list of requested related model functionalities to the first network entity using any of an existing information element, a newly-defined information element, existing NAS signaling/messages, newly-defined NAS signaling/messages, existing RRC signaling/messages, newly-defined RRC signaling/messages.

12. A method according to claim 4, in which the first network entity verifies the list of requested related model functionalities from each of the group of second network entities based on any of second entity subscription information, PLMN rules, second network entity capability to support AI/ML, second network entity indication of AI/ML capabilities to the first network entity, rules preconfigured in the communications network by any of a service provider, an application function, a network operator, an external entity, via OAM, any combination thereof.

13. A method according to claim 4, in which, for each of the group of second network entities, the allocated list of verified related model functionalities includes any of the list of requested related model functionalities, part of the list of requested related model functionalities, a different list of related model functionalities to those in the list of requested related model functionalities.

14. A method according to claim 4, in which the allocated list of verified related model functionalities further includes any of model functionality IDs, model functionality layers, model functionality layer IDs.

15. A method according to claim 4, in which the first network entity provides the allocated list of verified related model functionalities to each of the group of second network entities using any of an existing information element, a newly-defined information element, existing NG signaling/messages, newly-defined NG signaling/messages.
